(19) United States
(12) Patent Application Publication
(10) Pub. No.: US 2015/0020592 A1
(43) Pub. Date: Jan. 22, 2015

(54) RESISTIVE TYPE ACCELERATION SENSOR

(71) Applicant: SAMSUNG ELECTRO-MECHANICS CO., LTD., Suwon-si (KR)

(72) Inventors: Young Kil CHOI, Suwon-si (KR); Seung Chul PYO, Suwon-si (KR); Jun Kyung NA, Suwon-si (KR); Sung Tae KIM, Suwon-si (KR); Chang Hyun KIM, Suwon-si (KR)

(21) Appl. No.: 14/331,872

(22) Filed: Jul. 15, 2014

(30) Foreign Application Priority Data
Jul. 16, 2013 (KR) 10-2013-0083567

(51) Int. Cl. G01P 15/08

(52) U.S. Cl. CPC G01P 15/0802
USPC 73/514.33

(57) ABSTRACT

Disclosed herein is a resistive type accelerator sensor, including: a sensor unit; and a continuous time sigma-delta ADC including an input unit which receives an analog input signal transferred from the sensor unit, an addition circuit which is coupled with the input unit to receive the analog input signal and an analog feedback signal transferred from DAC to provide a summed signal, an integrator which integrates the summed signal transferred from the addition circuit, a comparator which converts an integrated signal transferred from the integrator into a digital signal, and an output unit which transfers the digital output signal.

This application claims the benefit under 35 U.S.C. Section 119 of Korean Patent Application Serial No. 10-2013-0083567 entitled “Resistive Type Acceleration Sensor” filed on Jul. 16, 2013, which is hereby incorporated by reference in its entirety into this application.

### BACKGROUND OF THE INVENTION

1. Technical Field

The present invention relates to a resistive type acceleration sensor, and more particularly, to a resistive type acceleration sensor including a continuous time sigma-delta ADC.

2. Description of the Related Art

An inertial sensor has been used in various applications, for example, military such as an artificial satellite, a missile, and an unmanned aircraft, a vehicle such as an air bag, electronic stability control (ESC), and a black box for a vehicle, hand shaking prevention of a camcorder, motion sensing of a mobile phone or a game machine, navigation, and the like.

Generally, an acceleration sensor is classified into a capacitive type and a resistive type depending on a displacement detection method.

The most generally used acceleration sensor is a capacitive type. Since the capacitive type acceleration sensor itself does not consume current, the capacitive type acceleration sensor is able to be designed at low power and reduce noise at a low frequency band by using a modulation signal applied when being configured.

However, since the capacitive type acceleration sensor itself may not generate a bias voltage, the capacitive type acceleration sensor needs to add a bias voltage circuit in a sensing circuit after a sensor terminal.

Today, there are many Patent Applications for the capacitive type acceleration sensor which has been researched by many companies and many Patents for a sensing circuit suitable for the capacitive type acceleration sensor.

Meanwhile, since a resistive type acceleration sensor, which is an acceleration sensor configuring X-axis, Y-axis, and Z-axis resistors, may consume current, the resistive type acceleration sensor has been used in a relatively narrower field than the capacitive type acceleration sensor in that it has been used in applications which target less power consumption.

However, since the resistive type acceleration sensor itself divides voltage to generate a bias voltage, the resistive type acceleration sensor has a large advantage in that the sensing circuit may use the generated bias voltage as it is. Therefore, the resistive type acceleration sensor need not include a circuit for additional voltage generation which is required to operate the sensing circuit.

As an analog-to-digital converter (ADC) which is used in a resistive type acceleration sensor system according to the related art, a successive approximation register ADC (SAR ADC) and a cyclic ADC have been mainly used.

The SAR ADC and the cyclic ADC have an advantage in power efficiency and an area occupying a circuit in the system for representing a resolution of about 8 bits or 10 bits, but has the reduced efficiency when being used for resolution larger than the above resolution.

Specifications of the recently emerging acceleration sensor system have a resolution from 12 bits to 16 bits and the ADC used in the system is being replaced with the sigma-delta ADC which supports a high resolution.

Generally, the sigma-delta ADC has been mainly used in audio applications and uses an over sampling method and a noise shaping method using a closed loop such that the sigma-delta ADC may represent the highest resolution in the existing ADC.

As the resistive type acceleration sensor, a resistive type acceleration sensor configured to include a sensing circuit configured of an amplifier and a low pass filter and a discrete time sigma-delta ADC has been provided.

When the resistive type acceleration sensor is applied with a force transferred from the outside, the resistive type acceleration sensor in which the signal is processed by the sigma-delta ADC converts and outputs the force into an electrical analog signal. The output signal suffers from an amplification action of the amplifier and a filtering action of a filter and then is transferred to an input of the discrete time sigma-delta ADC, which is in turn converted into a digital signal.

However, the resistive type acceleration sensor according to the related art does not meet a tendency of compactness of electronic devices since the sensing circuit occupies an unnecessary space and has a complicated structure.

### RELATED ART DOCUMENT

### Patent Document

(Patent Document 1) Korean Patent Laid-Open Publication No. 2006-0069244

### SUMMARY OF THE INVENTION

An object of the present invention is to provide a resistive type acceleration sensor which is configured to include a sensor unit and a continuous time sigma-delta ADC to replace a sensing circuit in the continuous time sigma-delta ADC.

According to an exemplary embodiment of the present invention, there is provided a resistive type acceleration sensor, including: a sensor unit; and a continuous time sigma-delta ADC which receives a signal transferred from the sensor unit to perform amplification and low pass filtering on the signal.

The continuous time sigma-delta ADC may include: an input unit which receives an analog input signal transferred from the sensor unit, an addition circuit which is coupled with the input unit to receive the analog input signal and an analog feedback signal transferred from DAC to provide a summed signal, an integrator which integrates the summed signal transferred from the addition circuit, a comparator which converts an integrated signal transferred from the integrator into a digital signal, and an output unit which transfers the digital output signal.

The integrator may be configured to include an Op-Amp, a resistor, and a feedback capacitor, and the resistor may be connected to a non-inversion terminal of the Op-Amp, and as a negative feedback a capacitor may be an active type integrator which is connected to a non-inversion terminal and an output terminal of the Op-Amp.

An input resistor of the integrator may use a resistor of the sensor unit.

The analog input signal may be amplified by controlling a coefficient of the capacitor of the integrator.

The low pass filtering of the amplification signal may be performed by controlling a transfer function of the integrator.

The sensor unit may be a bridge circuit which is configured of a resistor element.

The resistor element may be configured of first to fourth resistor elements, a connection point between the first resistor element and the second resistor element and a connection point between the third resistor element and the fourth resistor element may be an output terminal, a connection point between the first resistor element and the fourth resistor element may be an input terminal, and a connection point between the second resistor element and the third resistor element may be connected to a ground terminal.

The continuous time sigma-delta ADC may be configured of a cascade type of a single loop to improve an amplification factor.

The continuous time sigma-delta ADC may be configured of a cascade type of a single loop and a multi loop to improve an amplification factor.

### BRIEF DESCRIPTION OF THE DRAWINGS

FIG. 1 is a block diagram illustrating a resistive type acceleration sensor according to an exemplary embodiment of the present invention.

FIG. 2 is a circuit diagram illustrating a continuous time sigma-delta ADC.

FIG. 3 is a circuit diagram illustrating another continuous time sigma-delta ADC.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

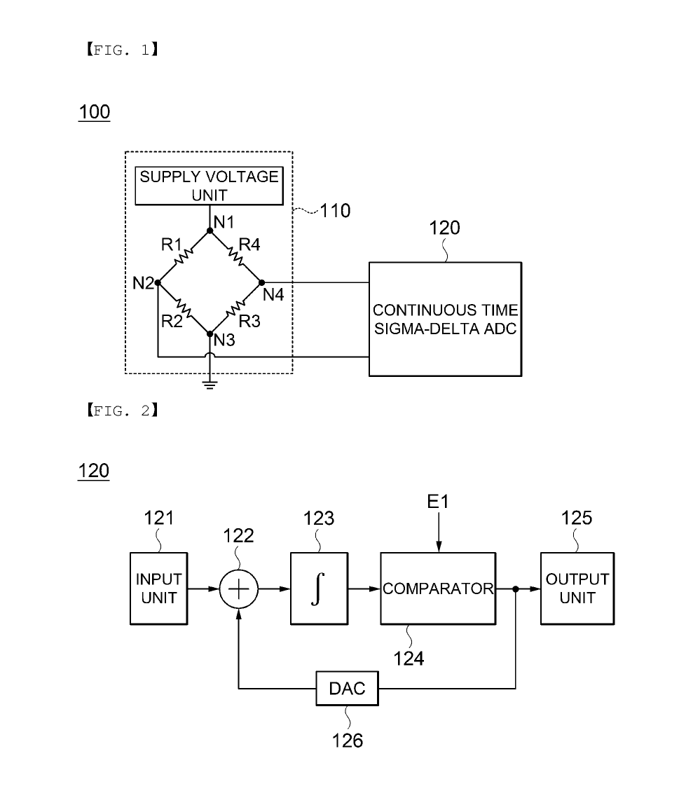

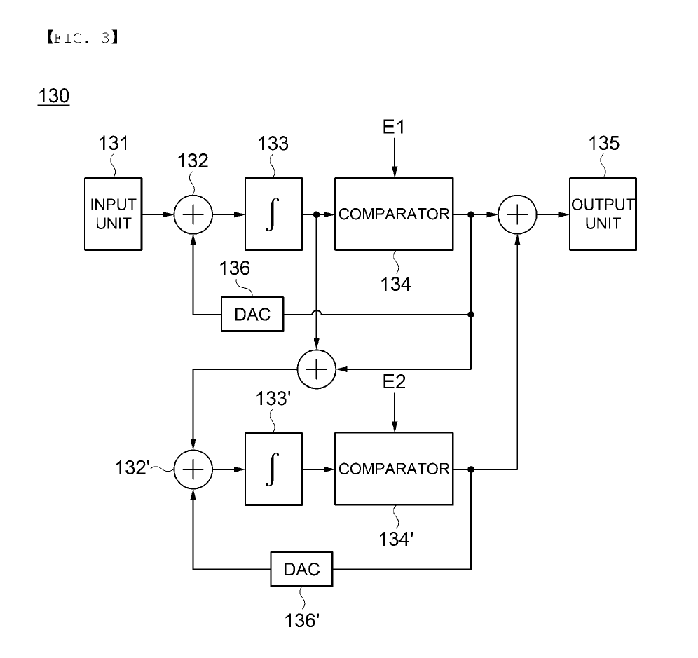

FIG. 1 is a block diagram illustrating a resistive type acceleration sensor 100 according to an exemplary embodiment of the present invention and FIG. 2 is a circuit diagram illustrating a continuous time sigma-delta ADC 120.

As illustrated, the resistive type acceleration sensor 100 according to the exemplary embodiment of the present invention may be configured to include a sensor unit 110 and a continuous time sigma-delta ADC which receives an analog signal of the sensor unit 110 and processes the analog signal.

The sensor unit 110 configures a front end of the resistive type acceleration sensor 100 and serves to measure acceleration by sensing elastic deformation of a piezoresistor and generate an analog type electrical signal when the piezoresistor is elastically deformed due to the change in acceleration.

The sensor unit 110 may be configured to include four resistor elements of a first resistor element R1, a second resistor element R2, a third resistor element R3, and a fourth resistor element R4 to have a function of sensing voltage corresponding to a magnitude in acceleration, in which the resistor elements may form a bridge circuit.

In this configuration, the first to fourth resistor elements may be a gauge resistor of a strain gauge using a pressure resistance effect of changing the resistance value thereof when a resistor of metal or semiconductor is deformed.

In detail, the first to fourth resistor elements form four nodes and a second node N2 which is a connection point between the first resistor element R1 and a second resistor element R2 and a fourth node N4 which is a connection point between the third resistor element R3 and the fourth resistor element R4 may be set as an output terminal.

A first node N1 which is a connection point between the first resistor element R1 and the fourth resistor element R4 may be connected to a supply voltage unit as an input terminal and a third node N3 which is a connection point between the second resistor element R2 and the third resistor element R3 may be connected to a portion which is set at a reference potential and may generally be connected to a ground terminal GND so as to be grounded.

Therefore, when the acceleration is not displaced, a voltage difference between the N2 and the N4 which are the output terminal may not be generated and when the acceleration is displaced to change the resistance value of the first to fourth resistors, the voltage difference may be generated between the output voltages.

The continuous time sigma-delta ADC 120 may receive the potential difference generated between the output terminals N2 and N4, which is generated due to the change in acceleration, to perform the amplification and low pass filtering on the signal. That is, an analog signal induced from the output terminal of the sensor unit 110 may be changed to a digital signal without adding a separate signal sensing circuit.

The continuous time sigma-delta ADC 120 is illustrated in detail in a circuit diagram of FIG. 2.

In detail, the continuous time sigma-delta ADC 120 may be configured to include an input unit 121 which receives the analog input signal transferred from the sensor unit 110, an addition circuit 122 which is coupled with the input unit 121 to receive the analog input signal and an analog feedback signal transferred from a DAC 126 to provide a summed signal, an integrator 123 which integrates the summed signal transferred from the addition circuit 122, a comparator 124 which converts an integrated signal transferred from the integrator 123 into a digital signal, and an output unit which transfers the digital output signal.

The continuous time sigma-delta ADC 120 performs an operation on the input signal without performing a sampling process and the digital-to-analog converter (DAC) 126 transfers the analog feedback signal to the addition circuit 122 so as to match a clock signal.

The input unit 121 is briefly illustrated so as to receive the potential difference between the output terminals of the sensor unit 110 as the analog input. Further, the addition circuit 122 is coupled with a non-inversion terminal of the integrator 123 to add the analog feedback signal of the DAC 126 to the analog signal transferred from the input unit so as to provide the summed signal.

The integrator 123 receives the summed signal as an input of the non-inversion terminal of the integrator 123, and the integrator 123 is the active RC integrator 123 and as the input resistor of the integrator 123, the resistor of the sensor unit 110 may be used.

The integrator 123 is configured to include an Op-Amp, a resistor, and a feedback capacitor and the resistor is connected to a non-inversion terminal of the Op-Amp and as a negative feedback a capacitor is connected to the non-inversion terminal and an output terminal of the Op-Amp.

In the resistive type acceleration sensor 100 according to the exemplary embodiment of the present invention, the continuous time sigma delta ADC is connected to a later stage of the sensor unit and as the integrator 123, the active RC integrator 123 may generally be used and the resistor of the sensor unit 110 may be used instead of the resistor element of the integrator 123.

Therefore, when the resistance value is changed depending on the change in acceleration without adding a separate resistor connected to the non-inversion terminal of the integrator 123, the integrator 123 may be substituted into a preset equivalent resistor, such that a circuit configuration of the integrator may be simply implemented.

The resistance value of the sensor unit 110 may be regarded as the input resistance value which is viewed from the non-inversion terminal of the integrator 123 and the resistor of the sensor unit 110 may be replaced with the input resistor of the integrator 123.

Further, since the sensor unit 110 configured of the resistor needs to include the supply voltage unit which applies an external voltage for forming the potential difference by using the change in acceleration as the change in resistance, the voltage formed in the sensor unit 110 may be utilized as the bias voltage for driving the amplifier of the continuous time sigma-delta ADC 120. That is, the power consumption which is a problem of the resistive type acceleration sensor 100 according to the related art may be reduced, such that it is advantageous in the design of power.

The comparator 124 may be a quantizer which converts the integrated signal output from the integrator into the digital signal. It is apparent that the signal generated from the comparator 124 may be applied to a single bit type and a multi-bit type.

The DAC 126 may convert the digital signal output from the comparator 124 into the feedback analog signal indicated by the addition circuit. Generally, the DAC 126 may be implemented by a resistor or a capacitor.

Meanwhile, the continuous time sigma-delta ADC 120 may serve to convert the electrical signal transferred from the sensor unit 110 at the front end thereof into the digital signal and to perform the amplification and the low pass filtering on the electrical signal.

The amplification of the signal may be controlled by a coefficient of the capacitor of the integrator 123. The amplification ratio may be simply implemented by a variable capacitor and therefore, a circuit including a separate amplifier is not required.

The filtering of the signal may be controlled by a transfer function of the integrator 123. That is, the low pass filter function having a cut-off frequency meeting a use purpose may be implemented by controlling the variable capacitor and the resistor of the integrator 123.

The continuous time sigma-delta ADC receives the continuously variable analog input signal and integrates the analog input signal, such that factors of stabilizing the output of the Op-Amp used at the time of implementing the integrator 123 may be more relieved than the discrete time sigma-delta ADC.

Further, the continuous time sigma-delta ADC may not require an anti-aliasing filter, may also be implemented by a low order structure, and may have less power consumption.

However, when the signal of the sensor unit 110 is low, and thus there is a need to amplify the signal, the coefficient of the continuous time sigma-delta ADC 120 may be increased in proportion thereto. This may be a factor of damaging the stability of the high-order ADC for high resolution.

The stability of the continuous time sigma-delta ADC 120 may be solved by using a cascade type or multi-stage noise shaping (MASH).

FIG. 3 illustrates the continuous time sigma-delta ADC 120 of a cascade type having a 1 order-1 order structure which may change an amplification coefficient. Herein, the ‘first order-first order’ means a type in which a 1-order integrator 123 is cascaded with a first-order integrator.

In this case, the ADC may be configured in a first order-multi order type or a first order-first order-first order type.

That is, the continuous time sigma-delta ADC is a cascade type of a single loop, such that the signal amplification factor having a small magnitude may be improved and the front end is provided with a single loop and is then cascaded with a multi loop, such that the signal amplification factor may be improved.

As set forth above, according to the exemplary embodiments of the present invention, the resistive type acceleration sensor can use the resistor of the active RC integrator of the continuous time sigma-delta ADC as the resistor of the sensor unit, thereby simplifying the circuit configuration and increasing the spatial utility of the electronic devices.

Further, according to the exemplary embodiments of the present invention, the voltage applied to the sensor unit configured of the resistor can be used as the bias voltage of the continuous time sigma-delta ADC, thereby reducing the power consumption and effectively managing the power.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A resistive type acceleration sensor, comprising:
a sensor unit; and
a continuous time sigma-delta ADC which receives a signal transferred from the sensor unit to perform amplification and low pass filtering on the signal.

2. The resistive type acceleration sensor according to claim 1, wherein the continuous time sigma-delta ADC includes: an input unit which receives an analog input signal transferred from the sensor unit, an addition circuit which is coupled with the input unit to receive the analog input signal and an analog feedback signal transferred from DAC to provide a summed signal, an integrator which integrates the summed signal transferred from the addition circuit, a comparator which converts an integrated signal transferred from the integrator into a digital signal, and an output unit which transfers the digital output signal.

3. The resistive type acceleration sensor according to claim 2, wherein the integrator is configured to include an Op-Amp, a resistor, and a feedback capacitor, the resistor is connected to a non-inversion terminal of the Op-Amp, and as a negative feedback a capacitor is an active type integrator which is connected to a non-inversion terminal and an output terminal of the Op-Amp.

4. The resistive type acceleration sensor according to claim 3, wherein an input resistor of the integrator uses a resistor of the sensor unit.

5. The resistive type acceleration sensor according to claim 3, wherein the analog input signal is amplified by controlling a coefficient of the capacitor of the integrator.

6. The resistive type acceleration sensor according to claim 5, wherein the low pass filtering of the amplification signal is performed by controlling a transfer function of the integrator.

7. The resistive type acceleration sensor according to claim 1, wherein the sensor unit is a bridge circuit which is configured of a resistor element.

8. The resistive type acceleration sensor according to claim 7, wherein the resistor element is configured of first to fourth resistor elements, a connection point between the first resistor element and the second resistor element and a connection point between the third resistor element and the fourth resistor element become an output terminal, a connection point between the first resistor element and the fourth resistor element becomes an input terminal, and a connection point between the second resistor element and the third resistor element is connected to a ground terminal.

9. The resistive type acceleration sensor according to claim 1, wherein the continuous time sigma-delta ADC is configured of a cascade type of a single loop to improve an amplification factor.

10. The resistive type acceleration sensor according to claim 1, wherein the continuous time sigma-delta ADC is configured of a cascade type of a single loop and a multi loop to improve an amplification factor.
